(19) United States
(12) Patent Application Publication
(10) Pub. No.: US 2025/0095366 A1
(43) Pub. Date: Mar. 20, 2025

(54) AUTOMATED METADATA GENERATION FROM FULL MOTION VIDEO

(71) Applicant: TACTIQL INC., Ottawa (CA)

(72) Inventors: Michael NELSON, Ottawa (CA); Rasha KASHEF, London (CA); Liam MARTIN, Toronto (CA); Hrag JEBAMIKYOUS, North York (CA); Mustafa ALJASIM, Mississauga (CA)

(21) Appl. No.: 18/887,030

(22) Filed: Sep. 16, 2024

(30) Foreign Application Priority Data
Sep. 18, 2023 (CA) 3212898

(51) Int. Cl. G06V 20/40; G06V 10/82; G06V 20/17; G06V 20/62

(52) U.S. Cl. CPC G06V 20/46; G06V 20/17; G06V 20/635; G06V 10/82; G06V 2201/10

(57) ABSTRACT

A system and method for generating metadata to accompany motion imagery data captured by an Unmanned Aerial System or similar platform extracts heads-up display content from the video content of the motion imagery data and correlates the extracted content with at least one metadata field to provide extracted metadata. The extracted metadata may be supplemented with synchronous metadata included in the motion imagery data, if any is available. Camera footprint coordinates are then computed using the extracted and optionally the supplementary metadata. Computation of the camera footprint coordinates may include simulating metadata such as sensor coordinates, timestamp, altitude, and/or heading angle, or deriving further metadata such as speed and rates of change of altitude and heading angle.

### CROSS-REFERENCE TO RELATED APPLICATIONS

This application claims priority to Canadian Patent Application No. 3212898 filed on Sep. 18, 2023, the entirety of which is incorporated herein by reference.

### TECHNICAL FIELD

This disclosure relates to automated extraction of information from motion imagery.

### TECHNICAL BACKGROUND

Full motion video (FMV) analysts use video to produce intelligence that can drive decision-making. In a geospatial intelligence application, analysts typically work in small teams of two or three people observing the video feed, logging and communicating what is observed, and creating an easy-to-read graphic-based product. While employed in these roles, FMV analysts rely on metadata broadcast with the video feed to help them gain an understanding of the depicted location on a map. This understanding is critical because FMV analysts must use location and time to express their observations, often within a short window of time and with as much confidence as possible. Use of the metadata broadcast with a video feed shortens the geographic referencing cycle; by combining information from a map with up-to-date imagery and the camera footprint, an FMV analyst can quickly cross-compare the video feed to the map to choose the best coordinates for their observations. As a best practice, an analyst always selects coordinates from the map versus relying on the Head Up Display (HUD) data.

A loss of metadata, therefore, hampers the analyst's ability to quickly geo-reference their observations. In practice, however, metadata may not be included with the FMV feed for a variety of reasons. When this occurs, the analyst must develop geographic references manually. This involves placing markers on their map based on coordinates displayed in the HUD and watching the feed for identifiable landmarks or objects on the map. This helps determine the correct map orientation and identify further points to boost confidence in their coordinates. This process is time-consuming and exacerbated by the lack of camera footprint information that might have been derivable from the metadata. During a dynamic FMV mission, this can be costly to the mission effectiveness.

### BRIEF DESCRIPTION OF THE DRAWINGS

In drawings which illustrate by way of example only embodiments of the present application,

FIG. 1 depicts example video frames captured by a UAV, including head-up display information.

FIG. 2 is a schematic diagram of an example pipeline for processing motion imagery data, including metadata extraction from video content.

FIG. 3 is a flowchart of an example process for the extraction of metadata from video content to obtain geolocation data.

FIG. 4 is a flowchart of an example process for generating metadata for computing a camera footprint.

FIG. 5 is a flowchart of an example process for detecting motion from video content.

FIG. 6 depicts an example video frame, including a visual identifier of a moving object.

FIG. 7 depicts an example video frame including visual identifiers of detected objects.

FIG. 8 is a schematic of a system for processing motion imagery data in accordance with the pipeline depicted in FIG. 2.

FIG. 9 is a schematic of a further system for processing motion imagery data implementing metadata extraction at edge computing devices.

### DETAILED DESCRIPTION

The example embodiments discussed below provide systems and methods for processing motion imagery data to generate metadata for consumption by systems such as geographic information systems (GIS) and/or geospatial intelligence (GEOINT) applications. Metadata is synthesized or generated from video content received in a video transport stream or file by recognizing and interpreting text burned into the imagery. The metadata generated from the video content may then be encoded and injected into a video transport stream or file together with the received video content. The resultant video transport stream or file, comprising newly-generated metadata, may then be provided as input to a consuming application such as a GIS or GEOINT application.

In some implementations, the received video transport stream may already comprise some metadata fields with values. The metadata generated from the video content may supplement missing values for existing fields. New metadata fields may be defined for the video transport stream and populated with the values generated from the video content.

Additionally, object detection and/or motion detection may be performed on the received video content to produce additional metadata identifying objects and/or motion in the video content. This additional metadata can be encoded and included in the resultant video transport stream or file.

Metadata synthesis, object detection, and motion detection may be accomplished with the use of machine learning models for text recognition and natural language processing, object detection, and motion detection. Because the video content in a single transport stream may be captured in a plurality of modes—for example, RGB and IR—these models may be trained on both RGB and IR content to enable the use of the same models on a single video stream, without the need to switch between models to complete a given task.

Operation of the systems and methods described below will be best understood in the context of motion imagery typically generated for military and intelligence purposes.

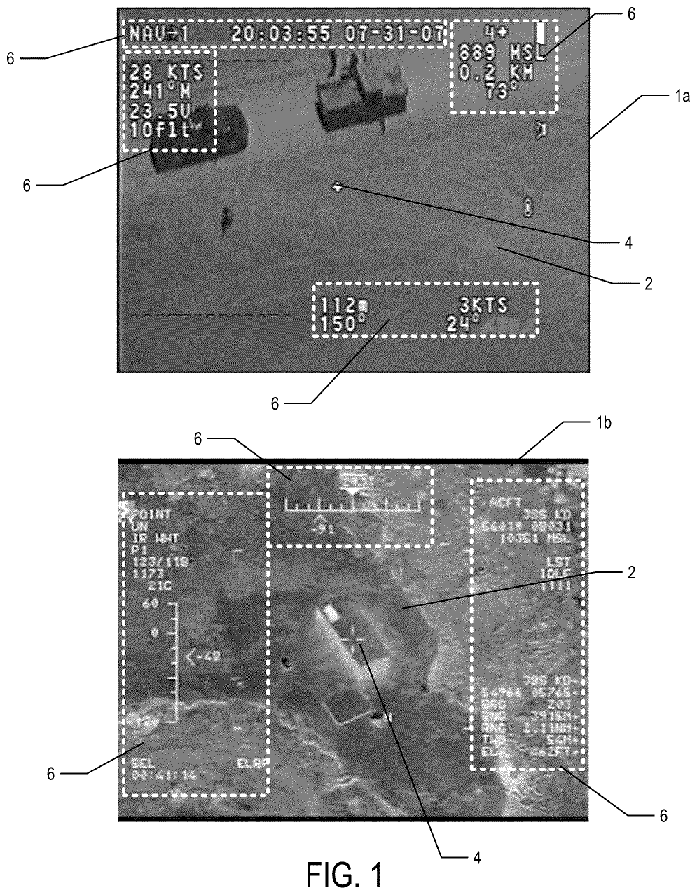

FIG. 1 depicts two example frames of full motion video (FMV) content that a UAV may generate. Generally, motion imagery generated by UAVs for military and intelligence purposes can comprise video content with a superimposed or overlaid head-up display (HUD) comprising text (alphanumeric) data concerning the captured video. This data can include sensor-collected or derived information; for example, in addition to information such as date and timestamp, the data may include airspeed, altitude, geospatial coordinates of the UAV, and geospatial coordinates of the center of the video frame. Other data may be displayed in the HUD as well. Some or all of this data may or may not be included as metadata in the FMV stream generated by the UAV. When a HUD is overlaid over the video content captured by the UAV sensor(s), the HUD content is burned into the video content that the UAV transmits to a receiving station; in other words, the HUD forms part of the video data transmitted by the FMV stream. As used herein, unless otherwise stated, “text” includes numeric and alphanumeric characters.

FIG. 1 depicts an example video frame 1a generated by a visible imaging sensor, such as a camera, mounted on a UAV. The video content 2 captured by the sensor can include terrain and objects. The HUD can include a crosshair 4 denoting the center of the video frame, also referred to as the “target” location or position. HUD text overlays the video content 2, often in a plurality of discrete regions 6 (indicated by dashed lines) surrounding the center of the frame. Since video content 2 comprises terrain and objects of varying colors and shapes, the contrast between the HUD text and the video content may vary. In the example of frame 1a, white HUD text is outlined in black to enhance the contrast between the text and the video content.

Video frame 1b is an example of video content generated by a UAV employing an infrared (IR) imaging sensor. Images produced by IR sensors are generally rendered monochromatically. The video content 2 in example frame 1b is rendered in greyscale. The HUD text overlays the video content 2 in several discrete regions, in different positions and sizes than the example of frame 1a. In this example, the HUD text is presented in white. Since it overlays a greyscale image, the contrast between the text and the video content may be poor.

While the HUD text content may be included in the synchronous metadata generated and transmitted as part of the video stream from the UAV, as noted above, in practice, some or all of this data may be missing from the metadata transmitted from the UAV. Accordingly, the example implementations below provide a system and method for generating metadata from the HUD content to provide a video transport stream including metadata, even though metadata may have been omitted in the original stream from the UAV.

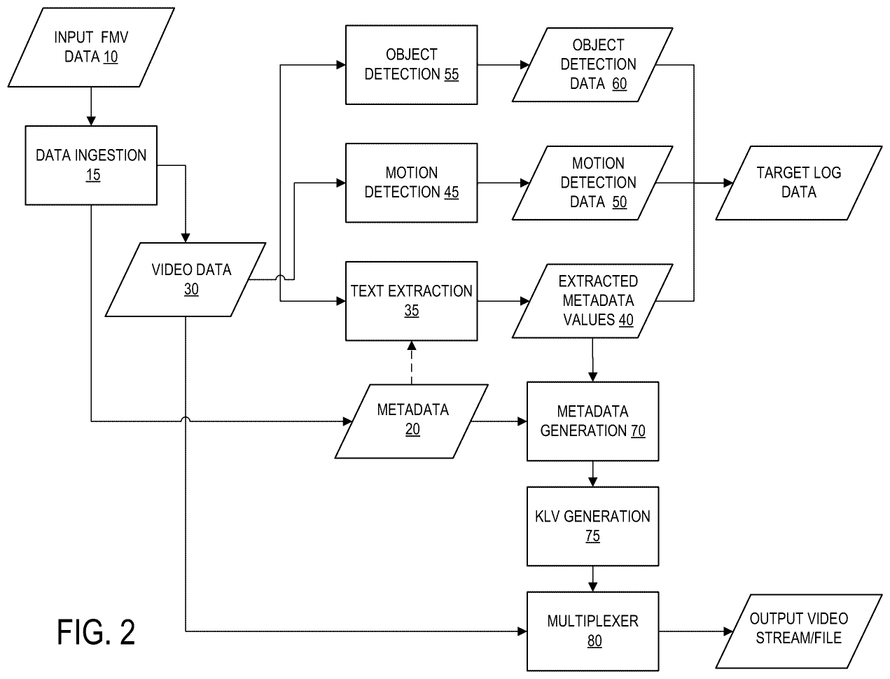

FIG. 2 is a schematic of a pipeline implementing multiple modules for generating metadata from video data in a received video transport stream, including the generation of metadata from the video content of the video data, such as geospatial information, motion detection, and object detection. Depending on the implementation, generated metadata may be recombined with the video data to produce a video transport stream comprising the generated metadata or alternatively stored separately from the video data. It will be understood by those skilled in the art that “metadata”, as used herein, may include information about the platform used to capture the video content (e.g., the imaging sensor or the vehicle or device comprising the sensor) as well as information about the video content itself, such as descriptive information. Such descriptive information can include information about the objects depicted in the video content (e.g., terrain, vehicles, structures, animals, individuals) and information obtained or derived from sensors, such as date and timestamp, airspeed, altitude, geospatial coordinates of the UAV and/or video frame, as mentioned above.

Incoming FMV data 10 is received from a source (not shown in FIG. 2) in a video transport stream. Although FMV data may be provided in any suitable file or stream format, real-time video content from a mobile platform such as a UAV is typically packaged in a digital container format together with any metadata generated by the platform. A typical digital container format is an MPEG transport stream in accordance with ISO/IEC 13818. In particular, when the FMV is intended for GEOINT purposes, the transport stream may be compliant with NATO Standardization Agreement (STANAG) 4609, which provides guidance on protocols and standards to ensure interoperability between different platforms. Thus, for example, the video data may be packaged in a MPEG-2 transport stream with any available metadata encoded in key-length-value (KLV) format in accordance with Motion Imagery Standards Board (MISB) Standard 0601 UAS Datalink Local Metadata Set, both of which are prescribed by STANAG 4609. Typical metadata fields defined for FMV in this context include a checksum field; UNIX timestamp; mission identifier (ID); platform heading angle, pitch angle, and roll angle; image source sensor; image coordinate system; sensor latitude, longitude, true altitude, horizontal field of view, vertical field of view, relative azimuth angle, relative elevation angle, relative roll angle, slant range, target width, and frame center longitude and elevation.

However, while the description herein refers to a transport stream and contemplates KLV-encoded metadata with specified fields, it will be understood that the examples and embodiments herein equally apply to other types of files, streams, encodings, and fields with appropriate modification that is within the skill of the person of ordinary skill in the art.

The incoming FMV data 10, whether in file or stream format, is initially received in a data ingestion pipeline 15, including a demultiplexer to obtain video data and as well as included metadata, if present. Extracted metadata obtained by demultiplexing may be synchronous or asynchronous. Any metadata 20 resulting from this process may be stored for subsequent reference by operators or further processing. The extracted video data 30 is then passed to one or more data curation pipelines, in which data is generated based on the video content. In FIG. 2, three example pipelines are shown: a text extraction module 35 producing extracted metadata values 40, a motion detection module 45 producing motion detection data 50, and an object detection module 55 producing object detection data 60. Execution of any of these modules is optional; for example, if only metadata generation based on HUD content is desired, the motion detection 45 and object detection 55 modules may not be employed. The video data 30 may be passed to each data curation pipeline in parallel, or in sequence.

The text extraction module 35 performs optical character recognition (OCR) and natural language processing (NLP) on the text content in individual video frames of the video data 30. Typical HUD content in a GEOINT application includes the sensor data mentioned above, together with symbols or abbreviations such as “KM” (kilometers) for distances, “KTS” (knots) for speed, and “EL” for elevation that may assist in identifying the type of sensor data being extracted from the video frame content. While certain content may be common to many HUDs, the specific appearance and content of the HUD may vary from platform to platform; for instance, the same data element (e.g., timestamp) may be located across the top of the frame in one HUD, but in the lower left-hand corner in another. Hence, the text extraction module is designed to be independent of the text location in the video frame. Units of measurement may not be in metric or SI in all HUDs. Accordingly, the text extraction module may carry out further processing on the extracted text to deal with different units of measurement and identify pertinent information for metadata generation. The HUD text can include values for one or more of the typical fields listed above.

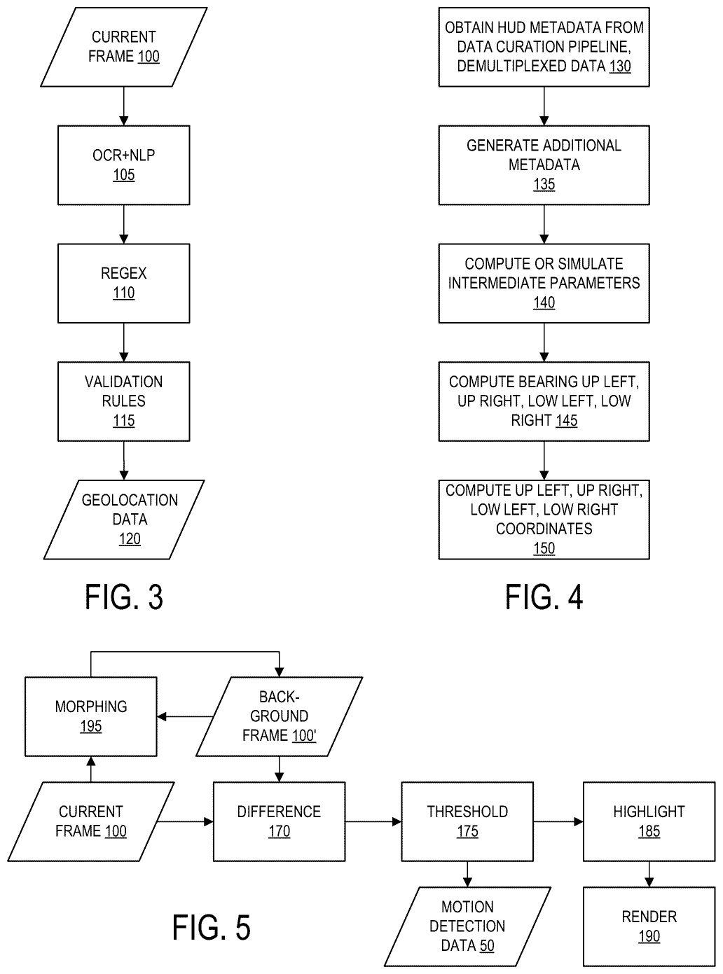

An example process for extracting metadata is illustrated in FIG. 3. At 105, a current frame 100 of the video data is processed by an optical character recognition (OCR) and natural language processing (NLP) module to recognize and extract text from the frame 100. The extracted text, which may be in the form of a set or list of raw text for the frame 100, will typically include the timestamp, as well as a series of numbers and characters representing various HUD elements such as geospatial coordinates. Since HUDs vary, the position of a given token (a string of characters) within the extracted raw text cannot be used to unambiguously designate the token as a geographic coordinate, elevation, angle, speed, etc. The raw text is passed to a regular expression (RegEx) module at 110 to identify the desired data from the raw text, including the content format, for example, whether coordinates are expressed in degrees/minutes/seconds (DMS) or Military Grid Reference System (MGRS) and filter out misdetected or invalid text. Thereby, the extracted raw text in the form of unstructured data is converted into a structured data format. Validation rules or heuristics may be applied at 115 to specify valid ranges for values in order to identify invalid values. For example, based on domain knowledge or platform specifications, it may be known that the sensor elevation cannot exceed 20 km, so any elevation data greater than this value is deemed invalid. Optionally, the metadata recognized from the video content may be compared to neighboring values obtained from the demultiplexed metadata 20, if such neighboring values exist. For example, if some synchronous speed metadata is available at timestamps proximate to the timestamp of speed data extracted from the video content, a rule may be applied to determine if the recognized metadata values are consistent (e.g., if synchronous metadata is available for times t=1 s and t=3 s, and the recognized metadata corresponds to t=2 s or 4 s, it may be expected that the recognized value will be within a certain range of the actual synchronous metadata).

Values that are determined to be invalid may be discarded, or alternatively, the process may return to 105 to attempt a new extraction. Misdetected or invalid text identified in this process may be subsequently manually annotated and used in retraining the OCR-NLP module. The end result is a set of extracted metadata values 40 for the frame, such as geolocation data 120 (latitude and longitude coordinates) and/or other sensor or platform data.

In one example, the text extraction module 35 employs the EasyOCR library (available from Jaided.ai, www.jaided.ai), in which character detection is implemented with the CRAFT algorithm and recognition with a convolutional recurrent neural network (CRNN) model.

Returning to FIG. 2, the extracted metadata values 40 obtained from the data curation pipeline are provided to a metadata generation module 70. The metadata generation module 70 may generate additional metadata that the platform is not configured to produce, and/or metadata that was not available for extraction by the text extraction module 35 because it was not included in the video content (i.e., the HUD). When the metadata fields are already present and populated with real values, the metadata generation module 70 may maintain those values, or alternatively replace the existing metadata values with those generated by the text extraction module 35. When metadata generation is employed to provide metadata that is completely missing from the FMV stream, the metadata fields are effectively created by the metadata generation module 70. The metadata thus generated by the metadata generation module 70 is then provided to a key-length-value (KLV) generation module 75 for processing so that it can be multiplexed with the video data.

For example, the camera footprint is valuable information for analysts. The camera footprint is generally expressed as the coordinates of a polygon representing the ground coverage (i.e., observable area) captured by a camera sensor and frame center coordinates at the polygon center. While GIS systems may be capable of automatically computing camera footprint information from input FMV, it is generally expected that the FMV will include sufficient synchronous metadata as input to the GIS system so that the GIS can compute the camera footprint coordinates. The GIS system cannot generate the camera footprint when insufficient (or no) metadata is provided with the video stream. Typical GIS systems require as many as a dozen parameters to be able to compute camera footprint, such as sensor latitude, sensor longitude, frame center latitude, frame center longitude, sensor altitude, frame center elevation, horizontal field of view (FoV), vertical field of view (FoV), platform heading angle, sensor relative azimuth angle, platform pitch angle, platform roll angle, and timestamp. It will be understood by those skilled in the art that some sensor parameters may also be considered equivalent to platform parameters and vice versa (e.g., the sensor altitude is considered to be the same as the platform altitude). Several of these parameters, such as sensor latitude, sensor longitude, sensor altitude, platform heading angle, and sensor relative azimuth angle, may be extractable from the HUD by the text extraction module 35, but others are not.

Accordingly, the metadata generation module 70 is configured to generate any missing required parameters that could not be extracted from the data curation pipeline. FIG. 4 provides one example process for generating missing data and deriving the camera footprint coordinates for at least a given frame (or timestamp) of the FMV. At 130, available HUD metadata is received by the metadata generation module 70 from the data curation pipeline. Some missing metadata may be supplemented by the actual metadata extracted from the FMV during demultiplexing, if available. Otherwise, at 135 the metadata generation module 70 generates missing metadata required for deriving the camera footprint.

The metadata generation module 70 may execute one or more trained machine learning models and mathematical modeling based on the known dynamics of the platform to obtain missing values. For example, features are first extracted from the available metadata to compute platform pitch angle and platform roll angle. The speed of the platform can be determined as distance/time; the distance value can be determined from the rate of change of sensor coordinates (difference in sensor latitude/longitude over elapsed time as determined from timestamps of the current frame and a previous frame). Similarly, the rate of change of the platform altitude (delta altitude) and the rate of change of the platform heading angle (delta heading) can be determined from the available metadata. A first machine learning model may be trained to determine the platform pitch angle given an input speed and delta altitude; a second machine learning model may be trained to determine the platform roll angle from an input speed and delta heading. Training data for these models may be derived from sample data collected for the platform.

Once the metadata has been extracted or otherwise generated, additional intermediate parameters required to compute the camera footprint are computed or simulated at 140. Some parameters may be simulated by the metadata generation module 70 based on inferences from other characteristics of the platform. For example, the computation of horizontal and vertical FoV values is dependent on sensor focal length data:

$${Fov}_{horizontal} = 2 * arctan ( \frac{image width}{2 * focal length} )$$

$${Fov}_{vertical} = 2 * arctan ( \frac{image height}{2 * focal length} )$$

where image width and image height are the width and height of the captured image, respectively; however, when focal length data is unavailable from the platform, predetermined constant values (expressed in radians) may be used for horizontal and vertical FoV instead. These predetermined constant values may be determined from the specifications of the particular platform supplying the FMV. Alternatively, the constants for the horizontal and vertical FoV may be determined from sample video data (e.g., correlating captured images to the actual camera footprint, determining appropriate values for the horizontal and vertical FoV for each frame based on the size of the actual footprint; then computing the average horizontal and vertical FoV values over all samples).

The camera footprint can be determined from a computed Distance, Aspect Ratio, Ground Elevation, Target Width, and Sensor Heading from these extracted or simulated values.

Distance is an absolute distance between the Platform Coordinates (sensor latitude and longitude, which are extractable from the HUD by the text extraction module 35) and the Frame Center Coordinates (frame center latitude and frame center longitude, also extractable by the text extraction module 35).

From Distance, sensor altitude (extractable by the text extraction module 35), and frame center elevation (extractable by the text extraction module 35), an intermediate Slant Range value can be computed as

$$Slant Range = \sqrt{{Distance}^{2}} + \sqrt{{( Sensor Altitude - Frame Center Elevation )}^{2}}$$

and Target Width is computed as

$$Target Width = 2 * Slant Range * tan ( \frac{{Fov}_{horizontal}}{2} )$$

Aspect Ratio is computed as the ratio of the horizontal FoV to the vertical FoV, which may be predetermined as described above.

Ground Elevation is computed as the difference between sensor altitude (extractable by the text extraction module 35) and frame center elevation (extractable by the text extraction module 35).

Sensor Heading is the sum of the platform heading angle (extractable by the text extraction module 35) and the sensor relative azimuth angle (extractable by the text extraction module 35), expressed as a percentage value.

From these parameters, the upper right, upper left, lower left, and lower right bearings may be computed at 145 from the following relationships:

$$\frac{Target Width}{2} \qquad [ 1 ]$$

$$\sqrt{{Distance}^{2}} + \sqrt{Ground {Elevation}^{2}} \qquad [ 2 ]$$

$$Target Width * \frac{Aspect Ratio}{2} \qquad [ 3 ]$$

$$arctan ( \frac{[ 1 ]}{Distance} ) ( in degrees ) \qquad [ 4 ]$$

$$arctan ( \frac{Distance}{Ground Elevation + 1} ) ( in degrees ) \qquad [ 5 ]$$

$$arctan ( \frac{[ 3 ]}{[ 2 ]} ) ( in degrees ) \qquad [ 6 ]$$

$$Ground Elevation * tan ( radians ( [ 5 ] + [ 6 ] ) ) \qquad [ 7 ]$$

$$Ground Elevation * tan ( radians ( [ 5 ] - [ 6 ] ) ) \qquad [ 8 ]$$

$$Distance - [ 8 ] \qquad [ 9 ]$$

$$[ 7 ] - Distance \qquad [ 10 ]$$

$$[ 1 ] - [ 9 ] * tan ( radians ( [ 4 ] ) ) \qquad [ 11 ]$$

$$[ 1 ] + [ 10 ] * tan ( radians ( [ 4 ] ) ) \qquad [ 12 ]$$

$$arctan ( \frac{[ 11 ]}{[ 9 ]} ) ( in degrees ) \qquad [ 13 ]$$

$$arctan ( \frac{[ 12 ]}{[ 10 ]} ) ( in degrees ) \qquad [ 14 ]$$

$$Upper Right Corner Bearing = ( Sensor Heading + [ 14 ] ) \% 360$$

$$Upper Left Corner Bearing = ( Sensor Heading + 360 - [ 14 ] ) \% 360$$

$$Lower Right Corner Bearing = ( Sensor Heading + 180 - [ 13 ] ) \% 360$$

$$Lower Left Corner Bearing = ( Sensor Heading + 180 + [ 13 ] ) \% 360$$

The corresponding upper right, upper left, lower right, and lower left corner coordinates of the camera footprint may then be computed at 150 from the corresponding Bearing value and Frame Center Coordinates (Lat_{FC}, Long_{FC}):

$$Corner Latitude ( in degrees ) = arcsin ( cos ( \frac{d}{R} ) * sin ( {Lat}_{FC} ) + sin ( \frac{d}{R} ) * cos ( {Lat}_{FC} ) * cos ( Bearing ) )$$

$$Corner Longitude ( in degrees ) = {Long}_{FC} + arctan ( cos ( \frac{d}{R} ) - sin ( {Lat}_{FC} ) * sin ( Corner Latitude ) , sin ( \frac{d}{R} ) * cos ( {Lat}_{FC} ) * sin ( Bearing ) )$$

where R is the Earth's radius (approximated as 6371008.8), and d and Bearing are as follows:

| Camera Footprint | | |
|---|---|---|
| Coordinate | d | Bearing |
| Upper Right Corner | \sqrt{[10]²} + \sqrt{[12]²} | Upper Right Corner Bearing |
| Coordinate | | |
| Upper Left Corner | \sqrt{[10]²} + \sqrt{[12]²} | Upper Left Corner Bearing |
| Coordinate | | |
| Lower Right Corner | \sqrt{[9]² } + \sqrt{[11]²} | Lower Right Corner Bearing |
| Coordinate | | |
| Lower Left Corner | \sqrt{[9]²} + \sqrt{[11]²} | Lower Left Corner Bearing |
| Coordinate | | |

Thus, the camera footprint can be derived from a combination of extracted and generated metadata, and optionally simulated values (such as the horizontal and vertical FoV). In some implementations, the camera footprint coordinates may be generated by the metadata generation module 70, such that the module 70 carries out all steps 130 to 150 in FIG. 4. In other examples, the metadata generation module 70 may generate additional metadata at 135, but not compute or simulate any of the further parameters or compute the camera footprint; these steps 140 to 150 may be implemented by another module in the system, such as the KLV generation module 75 in FIG. 2, or a separate GIS system or application executing in the same or a different computer system. In another example, the metadata generation module 70 may generate the additional metadata 135 and compute or simulate the further parameters 140. All such data may be provided as metadata to the KLV generation module 75, shown in FIG. 2. The extracted (and, if included, the generated and/or simulated) metadata values and their corresponding timestamps are mapped to corresponding metadata fields for the FMV and appropriately formatted for multiplexing with the video data 30. In these examples, the data is formatted as key-length-value (KLV) data by the KLV generation module 75, which then provides the KLV to the multiplexer 80 to generate a FMV stream or file with intact metadata.

Returning to FIG. 2, the extracted video data 30 may also be fed to a motion detection module 45, which detects motion within the scene depicted in the video data. One possible method for motion detection using background subtraction is shown in FIG. 5. A raster image from the current video frame 100 is converted to greyscale, if necessary, and differenced at 130 with an image from a background frame 100′, producing a raster of difference values. The difference values are compared to a predetermined threshold value at 135 to determine whether the corresponding pixel represents motion (i.e., a change) or not. Based on the identification of pixels representing motion, a mask or bounding coordinates representing the area of the frame image comprising motion may be generated as part of motion detection data 50. This motion detection data 50 would comprise a timestamp corresponding to the current video frame as well as the mask or bounding coordinate data.

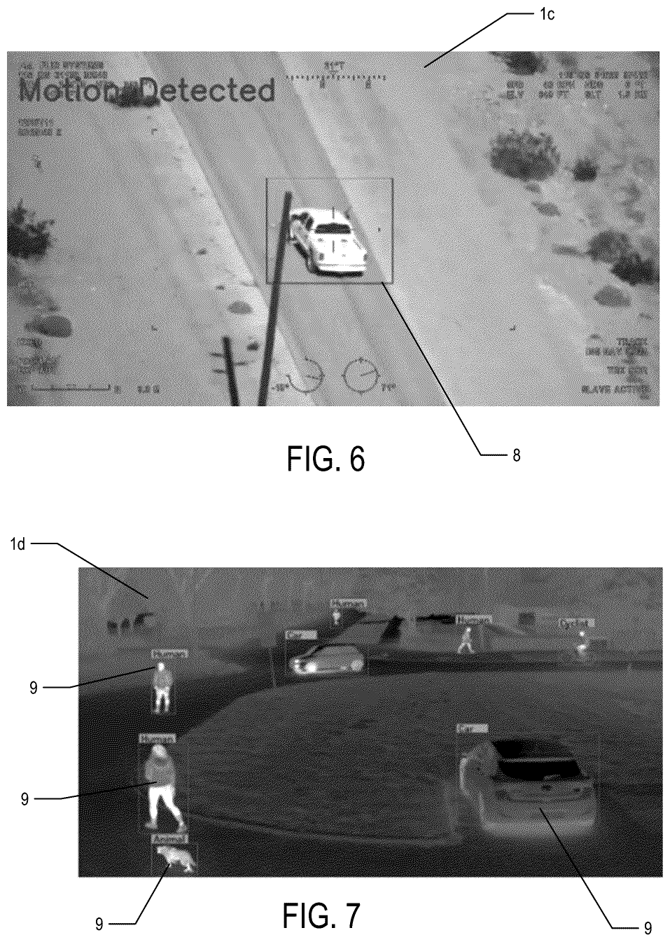

Those areas of the video frame comprising detected motion may be highlighted at 145, for example, by changing all those pixels in the mask to a specific color value and/or changing the pixels outside the mask to a specific, contrasting color value, or drawing a box as defined by the bounding coordinates on the image of the video frame. The modified video frame can then be rendered for display at 150 for review by an operator. FIG. 6 illustrates one example of motion detection highlighted in video frame 1c, in which the region comprising detected motion is indicated by a bounding box 8 defined by the bounding coordinates.

The motion detection data 50 may be stored separately from the video data. Referring again to FIG. 2, the motion detection data 50 may be stored in a target log 85, separate from the metadata for the FMV; however, in some implementations, the motion detection data 50 may also be provided to the metadata generation module 70 and incorporated into the metadata generated for the FMV.

The extracted video data 30 may further be fed to an object detection module 55 for detecting and classifying objects depicted in the video frame. While object detection algorithms are known, a particular challenge in GEOINT applications is the quality of the FMV generated by UAV platforms. In addition to potential poor resolution or contrast issues, the remote operator of a UAV may switch spontaneously between RGB (red-green-blue, visible) and IR (infrared) mode within a single FMV stream. Accordingly, the object detection module 55 must be able to detect objects in both RGB and IR images. This could be accomplished by detecting the mode for each video frame passed to the object detection, since IR imagery is typically greyscale, and providing the video frame to an appropriate object detection neural network trained on RGB or IR images, as the case may be. However, this step adds slight latency to the process.

Accordingly, in one implementation of the object detection module 55, a suitable classifier neural network is trained to recognize objects in multispectral imagery. In one implementation, the object detection network is a modified YOLOv5 (Ultralytics, Inc., ultralytics.com/yolov5) convolutional neural network object detection model (TPH-YOLOv5), in which the original prediction heads were replaced with Transformer Prediction Heads (TPH), and a further prediction head was added for detection of different scale objects. Convolutional Block Attention Modules (CBAM) were added to find attention regions in dense objects scenarios.

The training dataset may include annotated images from known sources, such as COCO (Common Objects in Context, cocodataset.org/) and VisDrone 2021 (Lab of Machine Learning and Data Mining, Tianjin University, aiskyeye.com/visdrone-2021/) as well as specially generated images and annotations suitable to the expected tasks. For example, surveillance missions may require a classifier adapted to discriminate between certain types of vehicles and buildings in RGB and IR images, whereas a rail inspection task will require images of various parts of tracks with and without defects. Since data may not be readily available to train the neural network for very specialized tasks, training data may be synthesized using a Generative Adversarial Network (GAN) seeded with a smaller set of images, then annotated by domain experts.

Video frames from the video data 30 are input to the object detection module 55, which utilizes the TPH-YOLOv5 model to detect and classify objects in the frame to produce object detection data 60, which comprises a classification together with bounding coordinates defining the region of the image comprising the detected and classified object, with an associated timestamp corresponding to the video frame. This object detection data 60 may also be stored in the target log 85; again, in some implementations, the object detection data 60 may also be provided to the metadata generation module 70 and incorporated into the metadata generated for the FMV.

The object detection data 60 may be rendered for display with the FMV in a similar manner described above in respect of the motion detection data 50. FIG. 7 illustrates an example rendering of a video frame 1d with various detected objects surrounded by a bounding box 9, labelled with text indicating how the object was classified (“Human”, “Car”, “Cyclist”, “Animal”).

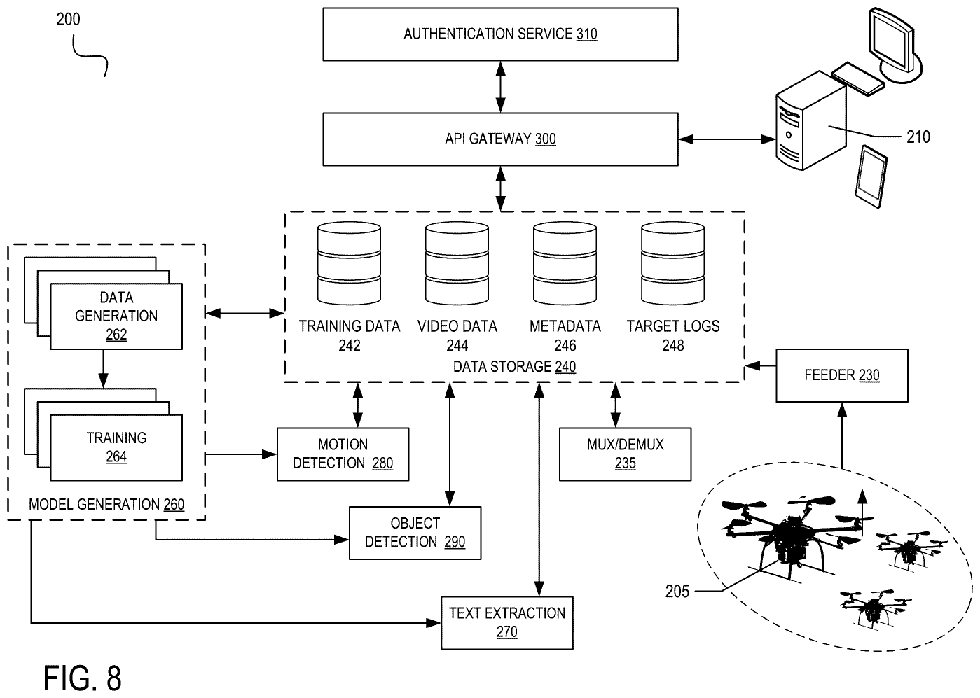

FIG. 8 illustrates a first example networked system 200 for implementing the example pipeline shown in FIG. 2. Various modules may be implemented as a cloud-based or networked data processing service communicating with one or more sources of FMV streams, in this example UAVs 205 and user computer systems 210. The users in this context may be the operators of the UAVs 205, but may additionally or alternatively be analysts or other consumers of the data generated by the system 200.

FIG. 8 illustrates one possible network topology for use in the system 200, and is by no means limiting. Two or more functions, stores, and modules may be implemented in a single data processing system and/or server or distributed across multiple data processing systems and servers; in the latter case, they are thus logically or physically remote from one another. Various elements of the system may be operated by the same operator of the UAVs 205 and/or the user computer systems 210, or alternatively operated by a third party.

Communications between various components and elements of the system 200, including the UAVs 205 and the user computer systems 210, may occur over private or public channels, preferably with adequate security safeguards as are known in the art. In particular, if communications take place over a public network such as the Internet, suitable encryption is employed to safeguard the privacy of data exchanged between the various components of the network environment.

In the example of FIG. 8, FMV streams from the UAVs 205 are received by system 200, and a feeder 230 feeds the received stream to a data storage system 240 comprising data stores 242, 244, 246, and 248. As noted above, these data stores may be implemented on different servers. Incoming streams may be fed to a multiplexer/demultiplexer 235 to extract the video data and any existing metadata, which may then be stored in the video data store 244 and metadata store 246, respectively. The text extraction 270, motion detection 280, and object detection 290 systems execute on input video frames received from the video data store 244. The text extraction system 270 returns the extracted metadata values for storage in a metadata store 246; the object detection and motion detection data may be stored in the metadata store 246 as well, or alternatively in target log store 248. Systems 270, 280 and 290 may generate data in any suitable format for storage. In one example, the output is generated in JSON notation, keyed to the video stream by time index.

Metadata values extracted by the text extraction system 270 and the video data extracted from the original stream may then be provided to the multiplexer/demultiplexer 235 to generate a new FMV stream, including the generated metadata, and stored in the data storage system 240.

The system 200 also includes a model generation system 260. Training data for training models is stored in the training data store 242 in the data storage system 240. The model generation system 260 may include data generation modules 262 for generating training data (e.g., using GANs, as described above), and training modules 264 for executing training of machine learning models for text extraction, motion detection, and object detection.

The user computer systems 210, which in this example are remote from system 200, may comprise devices such as desktop computers, workstations or terminals, and mobile computers such as laptops, tablets, and smartphones. Users may access the system 200 using a web browser or a special purpose application executing on their device 210. Access to the system may be provided by an API gateway 300, controlled by any suitable authentication service 310. Through the API gateway 300, the user computer systems 210 may retrieve FMV video streams, metadata, and target logs for rendering and display locally.

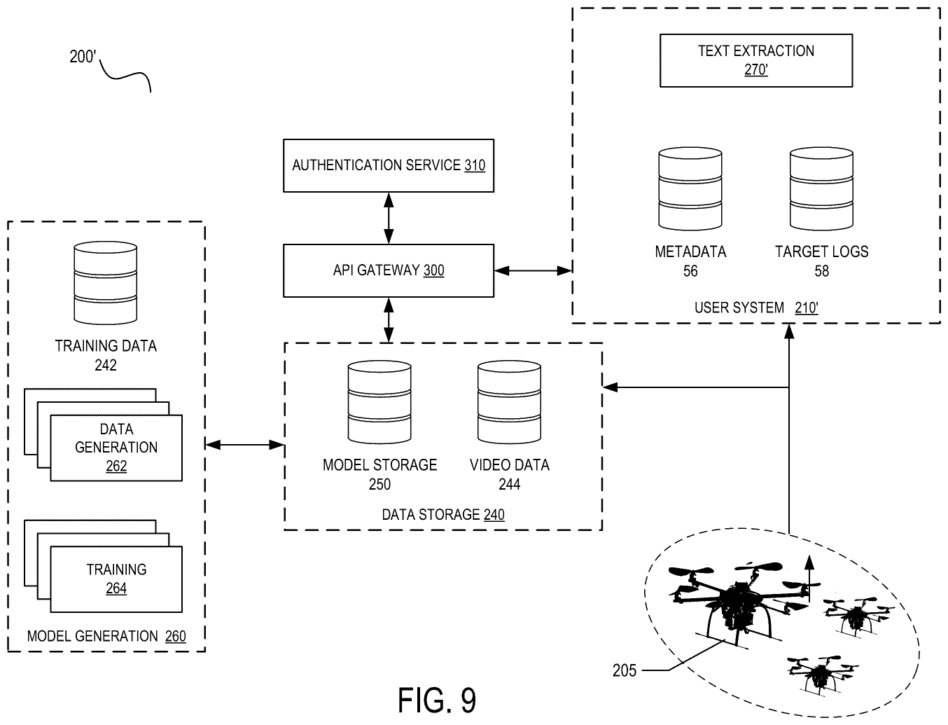

In the example system of FIG. 8, detection and extraction are executed in the system 200, preferably with sufficient computing resources to execute motion and object detection and metadata generation in real time or near real time as FMV video is received. In another implementation, shown in FIG. 9, these tasks, and the metadata generation in particular, are executed at the edge rather than in a central system. Fewer elements are shown in the system 200′ illustrated in FIG. 8 than in the system 200 of FIG. 8 for ease of exposition, but may be included. Except as discussed below, elements of the system 200 operate in a similar manner in FIG. 9.

In the example of FIG. 9, trained models stored in model storage system 250 are deployed to user computer systems 210′. These trained models may be optimized to reduce their size, and thereby their memory usage when executed. Model compression techniques, for example using TensorFlow Lite, are known in the art. Thus, models appropriate for the tasks to be implemented at the edge can be trained and deployed to individual users. Incoming FMV streams from the UAVs 205 are received by the system 200′ and may be demultiplexed to extract the video data and any existing metadata, which is then transmitted to the user system 210′. Alternatively, the FMV stream may be transmitted directly to the user system 210′, which then extracts the video data and existing metadata from the stream. The user system 210′ then executes text extraction 270′ on the frames of the video data, generally as described above, and stores the metadata thus generated locally in a metadata store 56.

According, there is provided a computer-implemented method for generating a camera footprint from motion imagery, comprising receiving, by one or more processors, input motion imagery data comprising video content captured by an Unmanned Aerial System (UAS) platform and including text overlaid over the captured video content; extracting, by the one or more processors, at least a portion of the text from the video content; correlating, by the one or more processors, the extracted text data with at least one metadata field to provide extracted metadata; and computing, by the one or more processors, a camera footprint using at least the extracted metadata.

In one aspect, computing the camera footprint comprises deriving camera footprint coordinates for at least one frame or timestamp of the motion imagery data.

In another aspect, the method further comprises supplementing the extracted metadata with metadata received with the motion imagery data, the extracted metadata thus supplemented being used to compute the camera footprint.

In still another aspect, the method further comprises supplementing the extracted metadata with simulated metadata, the simulated metadata being determined from specifications of the UAS platform, sample video data for the UAS platform, and/or one or more machine learning models receiving extracted metadata or metadata derived from the extracted metadata as input.

In a further aspect, the extracted metadata comprises sensor frame coordinates or frame sensor coordinates, timestamp, altitude, and heading angle; and/or the metadata derived from the extracted metadata comprises a speed, a rate of change of altitude, and a rate of change of heading angle; and/or the simulated data comprises a horizontal field of view and a vertical field of view; and/or the simulated data comprises a pitch angle, the method further comprising determining the pitch angle using a machine learning model with the speed and the rate of change of altitude as inputs; and/or the simulated data comprises a roll angle, the method further comprising determining the roll angle using a machine learning model with the speed and the rate of change of heading angle as inputs.

In another aspect, there is provided a method for generation of geolocation information for an object of interest in motion imagery, comprising: receiving input motion imagery in a video stream; determining whether the video stream comprises specified synchronous metadata; when the video stream does not comprise the specified synchronous metadata, determining whether the input motion imagery comprises head-up display (HUD) content; when the input motion imagery comprises head-up display (HUD) content, extracting, from at least one frame of the motion imagery data, text data from the HUD content; correlating the extracted text data with at least one metadata field; and storing the correlated text data as synchronous metadata associated with the motion imagery data.

In an aspect, the specified synchronous metadata comprises geographic coordinates for a target in a field of view of a camera used to capture content of the motion imagery, and the extracted text data is correlated with the geographic coordinates for the target position. In another aspect, the target is at a center of the field of view of the camera.

In a further aspect, the specified synchronous metadata comprises geographic coordinates for a UAV comprising a camera used to capture content of the motion imagery, and the extracted text data is correlated with the geographic coordinates for the UAV.

In still another aspect, the method further comprises executing an object detection module to detect at least one object in the input motion imagery; executing a motion detection module to detect motion of the at least one object in the input motion imagery; and generating a target log comprising geolocation information for the at least one object using the synchronous metadata.

There is also provided a method for synthesizing metadata from motion imagery, comprising: receiving input motion imagery data comprising video content captured by an Unmanned Aerial System (UAS) and including text overlaid over the captured video content; extracting at least a portion of the text from the video content; correlating the extracted text data with at least one metadata field; and storing the correlated text data as metadata associated with the motion imagery data.

In further aspects, the motion imagery data is comprised in a video stream; MPEG compliant; MISB ST 0601.8 compliant; and/or a motion imagery feed.

In another aspect, extracting comprises performing optical character recognition on frames of the video content to obtain recognized text.

In further aspects, correlating comprises performing natural language processing on the recognized text and/or comparing regular expressions to the recognized text.

In another aspect, a contrast level between the overlaid text and the captured video content varies over time; and the overlaid text may comprise head-up display (HUD) content, optionally comprising geographic coordinates of a camera or Unmanned Aerial Vehicle (UAV) used to capture the video content and/or geographic coordinates of a position within a field of view of a camera used to capture the video content. Said position may be the center of the field of view of the camera. Said overlaid text may be overlaid on a plurality of discrete regions of the video content.

In a further aspect, storing the correlated text data as metadata comprises storing the correlated text data in a distinct data structure from the motion imagery data, and/or storing the correlated text data as synchronous metadata with the motion imagery data. Optionally, the motion imagery data and synchronous metadata are stored in a video transport stream, and the correlated text data is stored using key-length-value encoding.

In another aspect, the input motion imagery data may comprise existing synchronous metadata, and storing the correlated text data as synchronous metadata comprises adding one or more fields to the existing synchronous metadata; and/or the input motion imagery data comprises existing synchronous metadata, and storing the correlated text data as synchronous metadata comprises storing the correlated text data in fields present in the existing synchronous metadata.

There is also provided non-transitory computer-readable media storing program code which, when executed by one or more processors of a computer system, cause the computer system to implement the methods described herein, and a computer system comprising one or more processors configured to implement the methods described herein.

The examples and embodiments above are presented only by way of example and are not meant to limit the scope of the subject matter described herein. Variations of these examples and embodiments will be apparent to those in the art and are considered to be within the scope of the subject matter described herein. For example, some steps or acts in a process or method may be reordered or omitted, and features and aspects described in respect of one embodiment may be incorporated into other described embodiments.

The data employed by the systems, devices, and methods described herein may be stored in one or more data stores. The data stores can be of many different types of storage devices and programming constructs, such as RAM, ROM, flash memory, programming data structures, programming variables, and so forth. Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by one or more processors to perform the operations described herein. The media on which the code may be provided is generally considered to be non-transitory or physical.

Computer components, software modules, engines, functions, and data structures may be connected directly or indirectly to each other in order to allow the flow of data needed for their operations. Various functional units have been expressly or implicitly described as modules, engines, or similar terminology to emphasize their independent implementation and operation. Such units may be implemented in a unit of code, a subroutine unit, an object (as in an object-oriented paradigm), an applet, a script or another form of code. Such functional units may also be implemented in hardware circuits comprising custom VLSI circuits or gate arrays; field-programmable gate arrays; programmable array logic; programmable logic devices; commercially available logic chips, transistors, and other such components. Functional units need not be physically located together, but may reside in different locations, such as over several electronic devices or memory devices, capable of being logically joined for execution. Functional units may also be implemented as combinations of software and hardware, such as a processor operating on a set of operational data or instructions.

It should also be understood that steps and the order of the steps in the processes and methods described herein may be altered, modified and/or augmented and still achieve the desired outcome. Throughout the specification, terms such as “may” and “can” are used interchangeably. Use of any particular term should not be construed as limiting the scope or requiring experimentation to implement the claimed subject matter or embodiments described herein. Any suggestion of substitutability of the data processing systems or environments for other implementation means should not be construed as an admission that the invention(s) described herein are abstract, or that the data processing systems or their components are non-essential to the invention(s) described herein. Further, while this disclosure may have articulated specific technical problems that are addressed by the invention(s), the disclosure is not intended to be limiting in this regard; the person of ordinary skill in the art will readily recognize other technical problems addressed by the invention(s).

1. A computer-implemented method for synthesizing metadata from motion imagery, comprising:
receiving, by one or more processors, input motion imagery data comprising video content captured by an Unmanned Aerial System (UAS) platform and including text overlaid over the captured video content;
extracting, by the one or more processors, at least a portion of the text from the video content;
correlating, by the one or more processors, the extracted text data with at least one metadata field to provide extracted metadata; and
storing the extracted metadata associated with the motion imagery data.

2. The method of claim 1, wherein the extracted metadata comprises geographic coordinates for a position associated with a camera used to capture the video content.

3. The method of claim 2, wherein the geographic coordinates comprise geographic coordinates for a center of a field of view of the camera.

4. The method of claim 1, wherein the extracted metadata supplements metadata received with the motion imagery data.

5. The method of claim 4, wherein supplementing the extracted metadata comprises supplementing the extracted metadata with simulated metadata, the simulated metadata being determined from specifications of the UAS platform, sample video data for the UAS platform, and/or one or more machine learning models receiving extracted metadata or metadata derived from the extracted metadata as input.

6. The method of claim 5, wherein the extracted metadata comprises sensor frame coordinates or frame sensor coordinates, timestamp, altitude, and heading angle, and metadata derived from the extracted metadata comprises one or more of a speed, a rate of change of altitude, or a rate of change of heading angle.

7. The method of claim 6, wherein the simulated data comprises a pitch angle, the method further comprising determining the pitch angle using a machine learning model with the speed and the rate of change of altitude as inputs.

8. The method of claim 6, wherein the simulated data comprises a roll angle, the method further comprising determining the roll angle using a machine learning model with the speed and the rate of change of heading angle as inputs.

9. The method of claim 1, further comprising computing a camera footprint using at least the extracted metadata, wherein computing the camera footprint comprises deriving camera footprint coordinates for at least one frame or timestamp of the motion imagery data.

10. The method of claim 1, wherein a contrast level between the overlaid text and the captured video content varies over time.

11. A computer system, comprising:
at least one communications subsystem;
memory; and
at least one processor in operative communication with the at least one communications subsystem and memory, the at least one processor being configured to:
receive input motion imagery data comprising video content captured by an Unmanned Aerial System (UAS) platform and including text overlaid over the captured video content;
extract at least a portion of the text from the video content;
correlate the extracted text data with at least one metadata field to provide extracted metadata; and
store the extracted metadata associated with the motion imagery data.

12. The computer system of claim 11, wherein the extracted metadata comprises geographic coordinates for a position associated with a camera used to capture the video content.

13. The computer system of claim 12, wherein the geographic coordinates comprise geographic coordinates for a center of a field of view of the camera.

14. The computer system of claim 11, wherein the extracted metadata supplements metadata received with the motion imagery data.

15. The computer system of claim 11, wherein the at least one processor is configured to supplement the extracted metadata with simulated metadata, the simulated metadata being determined from specifications of the UAS platform, sample video data for the UAS platform, and/or one or more machine learning models receiving extracted metadata or metadata derived from the extracted metadata as input.

16. The computer system of claim 15, wherein the extracted metadata comprises sensor frame coordinates or frame sensor coordinates, timestamp, altitude, and heading angle, and metadata derived from the extracted metadata comprises one or more of a speed, a rate of change of altitude, or a rate of change of heading angle.

17. The computer system of claim 16, wherein the simulated data comprises a pitch angle, the at least one processor being configured to determine the pitch angle using a machine learning model with the speed and the rate of change of altitude as inputs.

18. The computer system of claim 16, wherein the simulated data comprises a roll angle, the at least one processor being configured to determine the roll angle using a machine learning model with the speed and the rate of change of heading angle as inputs.

19. The computer system of claim 11, wherein the at least one processor is further configured to compute a camera footprint using at least the extracted metadata, including deriving camera footprint coordinates for at least one frame or timestamp of the motion imagery data.

20. The computer system of claim 11, wherein a contrast level between the overlaid text and the captured video content varies over time.
